(19) United States
(12) Patent Application Publication
(10) Pub. No.: US 2026/0140974 A1
(43) Pub. Date: May 21, 2026

(54) DATA ENRICHMENT USING ARTIFICIAL INTELLIGENCE-BASED INTERACTIVE QUERY GENERATION

(71) Applicant: BANK OF AMERICA CORPORATION, Charlotte, NC (US)

(72) Inventors: Katherine Dintenfass, McLean, VA (US); Eytan Alon, Charlotte, NC (US); Joseph DelVescio, Charlotte, NC (US); Jennifer T. Linsenmayer, Davidson, NC (US); Kyle R. Mooney, San Francisco, CA (US); Charles Phillip Valentine, Charlotte, NC (US)

(73) Assignee: BANK OF AMERICA CORPORATION, Charlotte, NC (US)

(21) Appl. No.: 18/952,562

(22) Filed: Nov. 19, 2024

(51) Int. Cl. G06F 16/332; G06F 16/23

(52) U.S. Cl. CPC G06F 16/3329; G06F 16/235

(57) ABSTRACT

Enrichment of data records through the implementation of Artificial Intelligence (AI). Machine learning model(s) scan data records, such as user data records, to identify gaps. In response to identifying gaps in a data record, Generative AI is implemented to generate queries that that are user-specific and configured to address the gaps in the data record. The queries may be iteratively generated based on previous responses until the gap-filling data is identified. Once generated, the queries are presented to the data record subject. In specific instances, additional machine learning models, which have been trained on user behavior patterns, are implemented to determine optimal learning modalities and/or optimal communication channels for presenting the queries to the user. In response to presenting the queries, responses to the queries are received and the data record is updated based on the responses, such that, the updating addresses one or more of the identified gaps.

### FIELD OF THE INVENTION

The present invention is generally directed to data enrichment and, more specifically, implementing Artificial Intelligence (AI) in the form of Machine Learning (ML) and Generative AI to identify gaps in data records and, in response, generate queries that facilitate responses that serve to address the gaps in the data records.

### BACKGROUND

Cookies, in a computing context, are small text files stored on a user's device by a website that assist the website in tracking users'activities, preferences and the like. However, the use of cookies has become less common because of privacy concerns and related regulations. In this regard, certain regulations have required websites to inform users as to their use of cookies and/or data collection, which has subsequently led to a decline in the use of third-party cookies. Such regulations mandate transparency and provide users control over their data, making cookie use more challenging.

The most meaningful data for an entity to possess is zero-party data, i.e., data explicitly shared by user. Since the data is coming directly from the user, no inferences need be drawn when subsequently actions are taken as a result of the data. However, acquisition of zero-party data can be a daunting task, in that, users are prone to avoid interactions intended to acquire such data, not only for privacy concerns, but for time intrusions as well.

Therefore, a need exists to develop systems, computer-implemented methods, computer program products or the like that serve identify a need to acquire user data and, in response, intelligently determine not only what queries to ask the user to facilitate responses to the need, but also how to present the queries to the user in order ensure user responses.

### BRIEF SUMMARY

The following presents a simplified summary of one or more embodiments of the invention in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing the enrichment of data records through the implementation of Artificial Intelligence (AI). In this regard, the invention implements machine learning model(s) to scan data records, such as user data records, to identify gaps. A gap in a data record is not merely an entry field that is missing data but may also include a lack of data that would provide insight into the behaviors of the user, as well as predicted behaviors, preferences of the user and intents, such as goals of the user. In response to identifying gaps in a data record, the invention uses Generative AI to generate one or more queries that that are data record-specific, e.g., user-specific and configured to address one or more of gaps in the data record. Once generated, the queries are presented to the data record subject, e.g., user, responses to the queries are received and the data record is updated based on the responses, such that, the updating addresses one or more of the identified gaps.

In specific embodiments of the present invention, additional machine learning models, which have been trained on user behavior patterns, are implemented to determine optimal learning modalities (i.e., the type of queries) to present the queries to the data record subject/user and/or optimal communication channels (e.g., email, text, online, widget or the like) for presenting the queries to the data record subject/user. In such embodiments of the invention, the optimal learning modality or communication channel may be specific to the query and/or the gap which it is configured to address.

In other specific embodiments of the invention, additional machine learning models and/or natural language processing (NLP) is used to identify patterns in the responses to the queries to detect or predict the emotional state of the data record subject/user. In such embodiments of the invention, the emotional state of the data record subject/user may serve to address the gap, while in other instances the emotional state is associated with the gap-filling data, such that update of the data record includes associating the detected or predicted emotional state of the data record subject/user gap-filling data.

In further specific embodiments of the invention, the machine learning models are implemented iteratively to determine and generate additional queries based on the responses received from data record subject/user. The additional queries may be need to hone in on or otherwise address the identified gap in the data record. In this regard, the additional queries continue to be determined and generated until the gap has been addressed. In those embodiments of the invention, in which additional machine learning models and/or natural language processing (NLP) are implemented to identify patterns in the responses to the queries to detect or predict the emotional state of the data record subject/user, the additional queries may be based not only on the previous responses provided by the data record subject/user, but also the detected or predicted emotional state of the data record subject/user.

A system for data enrichment defines first embodiments of the invention. The system includes a data repository having a first memory and one or more first computing processor devices in communication with the first memory. The first memory stores a plurality of data records, each data record associated with a user and including user-specific data. The system additionally includes a computing platform, such as a server(s) or the like, having a second memory and one or more second computing processor devices in communication with the second memory. The second memory stores a data record enrichment engine that includes artificial intelligence (AI). Data record enrichment engine is executable by at least one of the one or more computing processor devices. Data record enrichment engine is to access the data repository and implement one or more first machine-learning models to scan the plurality of data records and identify one or more gaps in one or more of the plurality of data records. For each of the identified one or more gaps in the one or more of the plurality of data records, data record enrichment engine is further configured to implement generative AI to generate one or more user-specific queries that are configured to address an associated gap in a corresponding data record. In response to generate the user-specific query(s), data record enrichment engine is further configured to present the user-specific query(s) to users associated with the data record(s), receive, from the users, responses to the user-specific query(s), and update the data record(s) based on the responses to the one or more user-specific queries. Updating the data record(s) serves to address at least one of the identified gaps in the corresponding data record.

In specific embodiments of the system, the data record enrichment engine is further configured to implement one or more second machine learning models trained on user behavior patterns to determine one or more optimal learning modalities (i.e., the type of query) for the one or more user-specific queries. In such embodiments of the system, the data record enrichment engine is configured to present the one or more user-specific queries to the users in the determined one or more optimal learning modalities. In related embodiments of the system, each of the one or more optimal learning modalities are specific to at least one of (i) a user-specific query and (ii) a gap in the corresponding data record.

In further specific embodiments of the system, the data record enrichment engine is further configured to implement one or more second machine learning models trained on user behavior patterns to determine one or more optimal communication channels for presenting the one or more user-specific queries to each of the users. In such embodiments of the system, the data record enrichment engine is configured to present the one or more user-specific queries to the users in the determined one or more optimal communication channels.

In still further specific embodiments of the system, the data record enrichment engine is further configured to implement at (i) one or more second machine learning models and/or (ii) natural language processing (NLP) to identify patterns in the responses to the one or more user-specific queries to detect or predict an emotional state of the user. In such embodiments of the system, the data record enrichment engine is configured to update the one or more of the plurality of data records based on the responses to the one or more user-specific queries, such that, updating includes associating to at least one of the one or more gaps. In other embodiments of the system, the detected or predicted emotional state of the user may form the gap.

In other specific embodiments of the system, the data record enrichment engine is further configured to, in immediate (i.e., real-time) response to receiving the responses to the users, implement the one or more machine learning models to determine and generate one or more additional user-specific queries based on one or more of the responses from an associated user, present the additional user-specific query(s) to user(s) associated with the data record(s), receive, from the user(s), responses to the additional user-specific query(s), and update the data record(s) based on the responses to (i) the user-specific query(s) and (ii) the additional user-specific queries. In related embodiments of the system, the record enrichment engine is further configured to implement (i) one or more second machine learning models and/or (ii) natural language processing (NLP) to identify patterns in the responses to the one or more user-specific queries to detect or predict an emotional state of the user. In such embodiments of the system, implementing the one or more machine learning models to determine and generate one or more additional user-specific queries is based on (i) one or more of the responses from an associated user and (ii) the detected or predicted emotional state of the user. In still further related embodiments of the system, the additional user-specific queries are determined and generated iteratively based previous responses from an associated user, such that the determination and generation of the one or more additional user-specific queries continues until an associated gap is addressed.

In further specific embodiments of the system, the gaps in data records include at least one of (i) a factual data gap, (ii) a behavioral gap, including predicted behavioral gap, (iii) a preference gap, and (iv) an intent gap.

A computer-implemented method for data enrichment defines second embodiments of the invention. The computer-implemented is method executed by one or more computing processor devices. The computer-implemented includes implementing one or more first machine-learning models to scan a plurality of data records and identify one or more gaps in one or more of the plurality of data records. For each of the identified one or more gaps in the one or more of the plurality of data records; the computer-implemented method further includes implementing generative AI to generate one or more user-specific queries. The user-specific query(s) are configured to address an associated gap in a corresponding data record. In addition, the computer-implemented method includes, presenting the one or more user-specific queries to users associated with the data record(s), receiving, from the users, responses to user-specific query(s), and updating the plurality of data records based on the responses to the one or more user-specific queries, wherein updating the one or more of the plurality of data records addresses at least one of the identified one or more gaps in the corresponding data record.

In specific embodiments the computer-implemented method further includes implementing second machine learning model(s) trained on user behavior patterns to determine (i) one or more optimal learning modalities and/or (ii) one or more optimal communication channels for presenting the one or more user-specific queries to a corresponding one of the users. In such embodiments of the computer-implemented method, presenting further determined presenting the one or more user-specific queries to the users using the determined (i) one or more optimal learning modalities and/or (ii) one or more optimal communication channels.

In other specific embodiments, the computer-implemented method, further includes implementing (i) one or more second machine learning models and/or (ii) natural language processing (NLP) to identify patterns in the responses to the one or more user-specific queries to detect or predict an emotional state of the user. In such embodiments of the computer-implemented method, updating further comprises updating the one or more of the plurality of data records based on the responses to the one or more user-specific queries, wherein updating includes associating the detected or predicted emotional state of the user to at least one of the one or more gaps. In other embodiments of the invention, the detected or predicted emotional state itself serves as the gap in the data record.

In still further specific embodiments, computer-implemented method includes, in immediate (i.e., real-time) response to receiving the responses to the users, implementing the one or more machine learning models to determine and generate additional user-specific query(s) based on one or more of the responses from an associated user, presenting the additional user-specific query(s) to user(s) associated with the data record(s), and receiving, from the users, responses to the additional user-specific query(s). In such embodiments of the computer-implemented method, updating further includes updating the one or more of the plurality of data records based on the responses to (i) the one or more user-specific queries and (ii) the one or more additional user-specific queries. In related embodiments computer-implemented method further includes implementing (i) one or more second machine learning models and (ii) natural language processing (NLP) to identify patterns in the responses to the one or more user-specific queries to detect or predict an emotional state of the user. In such embodiments of the computer-implemented method, implementing the one or more machine learning models to determine and generate the additional user-specific query(s) is based on (i) one or more of the responses from an associated user and (ii) the detected or predicted emotional state of the user. In further related embodiments of the computer-implemented method, the additional user-specific queries are determined and generated iteratively based previous responses from an associated user, such that the determination and generation of the one or more additional user-specific queries continues until an associated gap is addressed.

A computer program product including a non-transitory computer-readable medium defines third embodiments of the invention. The non-transitory computer-readable medium includes sets of codes. The sets of codes cause computing device(s) to implement first machine-learning model(s) to scan a plurality of data records and identify gap(s) in one or more of the data records. For each of the identified one or more gaps in the one or more of the plurality of data records, the sets of codes cause the computing device(s) to implement generative AI to generate one or more user-specific queries. The user-specific queries are configured to address an associated gap in a corresponding data record. Further, the sets of codes cause the computing device(s) to present the one or more user-specific queries to users associated with the one or more of the plurality of data records, receive, from the users, responses to the one or more user-specific queries, and update the one or more of the plurality of data records based on the responses to the one or more user-specific queries. Updating the data records addresses at least one of the identified one or more gaps in the corresponding data record.

In specific embodiments of the computer program product, the sets of codes further comprise a set of codes for causing the one or more computing devices to implement one or more second machine learning models trained on user behavior patterns to determine at least one of (i) one or more optimal learning modalities and (ii) one or more optimal communication channels for presenting the one or more user-specific queries to a corresponding one of the users. In such embodiments of the computer program product, the set of codes for causing the one or more computing devices to present are further configured to cause the computing device(s) to present the one or more user-specific queries to the users using at least one of the determined (i) one or more optimal learning modalities and (ii) one or more optimal communication channels.

In other specific embodiments of the computer program product the sets of codes further include a set of codes for causing the one or more computing devices to implement at least one of (i) one or more second machine learning models and (ii) natural language processing (NLP) to identify patterns in the responses to the one or more user-specific queries to detect or predict an emotional state of the user. In such embodiments of the computer program product, the set of codes configured to cause the one or more computing devices to update are further configured to cause the one or more computing devices to update the one or more of the plurality of data records based on the responses to the one or more user-specific queries. Updating includes associating the detected or predicted emotional state of the user to at least one of the one or more gaps.

In still further specific embodiments of the computer program product, the sets of codes further include sets of codes for causing the one or more computing devices to, in immediate response to receiving the responses to the users, implement the one or more machine learning models to determine and generate one or more additional user-specific queries based on one or more of the responses from an associated user, present the one or more additional user-specific queries to users associated with the one or more of the plurality of data records, and receive, from the users, responses to the one or more additional user-specific queries>In such embodiments of the computer program product, the set of codes configured to cause the one or more computing devices to update are further configured to cause the one or more computing devices to update the one or more of the plurality of data records based on the responses to the one or more user-specific queries and the one or more additional user-specific queries. In related embodiments of the computer program product, the sets of codes further comprise sets of codes for causing the one or more computing devices to implement at least one of (i) one or more second machine learning models and (ii) natural language processing (NLP) to identify patterns in the responses to the one or more user-specific queries to detect or predict an emotional state of the user. In such embodiments of the computer program product, the set of codes configured to cause the one or more computing devices to implement the one or more machine learning models to determine and generate one or more additional user-specific queries are further configured to cause the one or more computing devices to implement the one or more machine learning models to determine and generate one or more additional user-specific queries based on (i) one or more of the responses from an associated user and (ii) the detected or predicted emotional state of the user.

Thus, as described in detail below, present embodiments of the invention include apparatus, methods, computer program products and/or the like that provide for the enrichment of data records through the implementation of Artificial Intelligence (AI). In this regard, the invention implements machine learning model(s) to scan data records, such as user data records, to identify gaps. In response to identifying gaps in a data record, the invention uses Generative AI to generate one or more queries that that are data record-specific, e.g., user-specific and configured to address one or more of gaps in the data record. In specific instances the queries may be iteratively generated based on previous responses until the gap-filling data is identified. Once generated, the queries are presented to the data record subject, e.g., user. In specific instances, additional machine learning models, which have been trained on user behavior patterns, are implemented to determine optimal learning modalities (i.e., the type of queries) and/or optimal communication channels for presenting the queries to the user. In response to presenting the queries, responses to the queries are received and the data record is updated based on the responses, such that, the updating addresses one or more of the identified gaps.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the disclosure in general terms, reference will now be made to the accompanying drawings, wherein:

FIG. 1 is a schematic/block of a system for data record enrichment, in accordance with embodiments of the present invention;

FIG. 2 is a block diagram of a computing platform storing a data record enrichment engine, in accordance with embodiments of present invention;

FIG. 3 is a flow diagram of a method for data record enrichment, in accordance with embodiments of present invention;

FIG. 4 is a schematic/flow diagram of a system for Machine Learning (ML)model generation and training, in accordance with embodiments of the present invention; and

FIG. 5 is a block diagram of a system for Generative Artificial Intelligence (Gen AI) generation and training, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of skill in the art in view of this disclosure, the present invention may be embodied as a system, a method, a computer program product, or a combination of the foregoing. Accordingly, embodiments of the present invention may take the form of an entirely hardware embodiment, an entirely software embodiment (including firmware, resident software, micro-code, a.), or an embodiment combining software and hardware aspects that may be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer-readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for conducting operations of embodiments of the present invention may be written in an object oriented, scripted, or unscripted programming language such as JAVA, PERL, SMALLTALK, C++, PYTHON, or the like. However, the computer program code/computer-readable instructions for conducting operations of the invention may also be written in conventional procedural programming languages, such as the “C” programming language or similar programming languages.

Embodiments of the present invention are described below with reference to flowchart illustrations and/or block diagrams of methods or systems. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus to cause a series of operational events to be performed on the computer or other programmable apparatus to produce a computer implemented process such that the instructions, which execute on the computer or other programmable apparatus, provide events for implementing the functions/acts specified in the flowchart and/or block diagram block or blocks. Alternatively, computer program implemented events or acts may be combined with operator or human implemented events or acts in order to conduct an embodiment of the invention.

As the phrase is used herein, a processor may be “configured to” perform or “configured for” performing a certain function in a variety of ways, including, for example, by having one or more general-purpose circuits perform the function by executing particular computer-executable program code embodied in computer-readable medium, and/or by having one or more application-specific circuits perform the function.

“Computing platform” or “computing device” as used herein refers to a networked computing device within the computing system. The computing platform includes a processor, a non-transitory storage medium (i.e., memory), a communications device, and a display. The computing platform may be configured to support user logins and inputs from any combination of similar or disparate devices. Accordingly, the computing platform includes servers, personal desktop computer, laptop computers, mobile computing devices and the like.

Thus, systems, apparatus, and methods are described in detail below that provide for the enrichment of data records through the implementation of Artificial Intelligence (AI). In this regard, the invention implements machine learning model(s) to scan data records, such as user data records, to identify gaps. A gap in a data record is not merely an entry field that is missing data but may also include a lack of data that would provide insight into the behaviors of the user, as well as predicted behaviors, preferences of the user and intents, such as goals of the user. In response to identifying gaps in a data record, the invention uses Generative AI to generate one or more queries that that are data record-specific, e.g., user-specific and configured to address one or more of gaps in the data record. Once generated, the queries are presented to the data record subject, e.g., user, responses to the queries are received and the data record is updated based on the responses, such that, the updating addresses one or more of the identified gaps.

In specific embodiments of the present invention, additional machine learning models, which have been trained on user behavior patterns, are implemented to determine optimal learning modalities (i.e., the type of queries) to present the queries to the data record subject/user and/or optimal communication channels (e.g., email, text, online, widget or the like) for presenting the queries to the data record subject/user. In such embodiments of the invention, the optimal learning modality or communication channel may be specific to the query and/or the gap which it is configured to address.

In other specific embodiments of the invention, additional machine learning models and/or natural language processing (NLP) is used to identify patterns in the responses to the queries to detect or predict the emotional state of the data record subject/user. In such embodiments of the invention, the emotional state of the data record subject/user may serve to address the gap, while in other instances the emotional state is associated with the gap-filling data, such that update of the data record includes associating the detected or predicted emotional state of the data record subject/user gap-filling data.

In further specific embodiments of the invention, the machine learning models are implemented iteratively to determine and generate additional queries based on the responses received from data record subject/user. The additional queries may be need to hone in on or otherwise address the identified gap in the data record. In this regard, the additional queries continue to be determined and generated until the gap has been addressed. In those embodiments of the invention, in which additional machine learning models and/or natural language processing (NLP) are implemented to identify patterns in the responses to the queries to detect or predict the emotional state of the data record subject/user, the additional queries may be based not only on the previous responses provided by the data record subject/user, but also the detected or predicted emotional state of the data record subject/user.

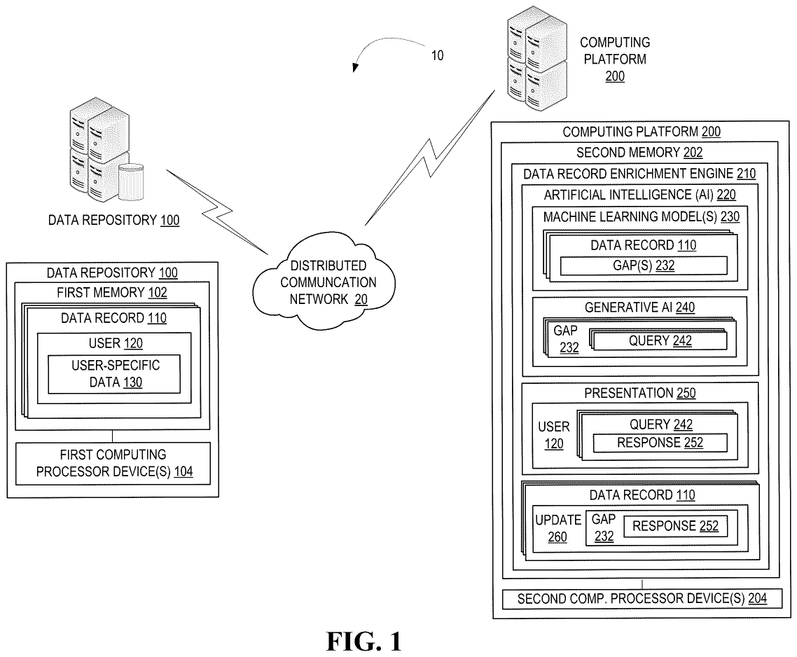

Referring to FIG. 1, a schematic/block is presented of a system 10 for data record enhancement, in accordance with embodiments of the present invention. The system 10 is implemented amongst a distributed communication network 20, which may include the Internet, one or more intranets, cellular network(s) or the like. The system includes a data repository 100 having a first memory 102 and one or more first computing processor devices 104 in communication with the first memory 102. First memory 102 stores a plurality of data records 110. Each data record is associated with a user 120 and is configured to store user-specific data 130.

System 10 additionally includes computing platform 200, which may comprise one or more servers or any other suitable computing device(s). Computing platform 200 includes second memory 202 and one or more second computing processor devices 204 in communication with second memory 202. Second memory 202 of computing platform 200 stores data record enrichment engine 210, which is executable by at least one of the computing processor device(s) 204 and includes artificial intelligence 220. Data record enrichment engine 210 is configured to implement machine learning (ML) model(s) 230 to access and scan the plurality of data records 110 to identify gaps 232 in the user specific data 130 of the plurality of data records 232. Gaps 232, as used herein, are not limited to unfilled data entry fields within a data record 110 but may include any data that would be beneficial to the data record holder as determined by the ML model(s) 230.

For each of the one or more gaps 232 in one or more of the data records 110, data record enrichment engine 210 is configured to implement Generative AI (GenAI) 240 to generate one or more user-specific queries 242. The user-specific queries 242 are configured to solicit responses from a corresponding user 120 that serve to address an associated gap 232 in the corresponding data record 110.

In response to generating the user-specific queries 232, data record enrichment engine 210 provides for presentation 250/communication of the user-specific queries 242 to the corresponding user 120 and, in response to presentation 250, receiving response(s) 252 to each of the one or more user-specific queries 252.

In response to receiving the response(s) 252, data record enrichment engine 210 is configured to update 260, corresponding data record(s) 110 based on the responses 252 to the user-specific queries 242. Update 260 of the data record(s) 110 addresses at least one of previously identified gaps 232 in the corresponding data record 110.

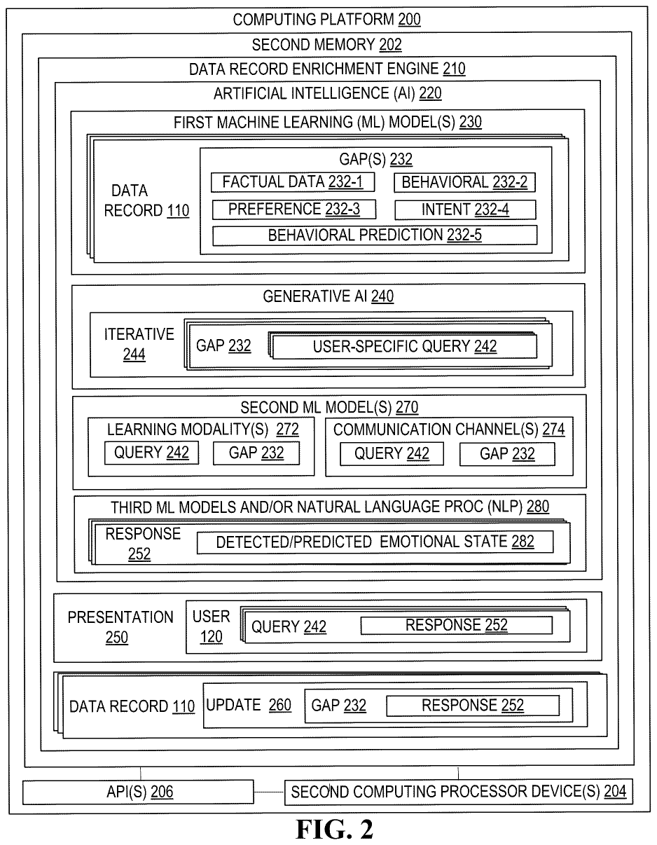

Referring to FIG. 2, a block diagram is depicted of computing platform 200 highlighting various alternate embodiments of the system 10 shown and described in relation to FIG. 1, in accordance with embodiments of the present invention. Computing platform 200 may comprise one or multiple computing devices, such servers or the like. As previously discussed in relation to FIG. 1, computing platform 200 includes memory 202, which may comprise volatile and/or non-volatile memory, such as read-only memory (ROM) and/or random-access memory (RAM), EPROM, EEPROM, or any memory common to computing platforms. Moreover, memory 202 may comprise cloud storage, such as provided by a cloud storage service and/or a cloud connection service.

Further, computing platform 200 includes one or more computing processor devices 204, which may be an application-specific integrated circuit (“ASIC”), or other chipset, logic circuit, or other data processing device. Computing processor device(s) 204 may execute one or more application programming interface (APIs) 206 that interface with any resident programs, such as data record enrichment engine 210 or the like, stored in memory 202 of computing platform 200 and any external programs. Computing platform 200 includes various processing sub-systems (not shown in FIG. 2) embodied in hardware, firmware, software, and combinations thereof, that enable the functionality of computing platform 200 and the operability of computing platform 200 on a distributed communication network, such as distributed communication network 20 shown in FIG. 1. For example, processing sub-systems allow for initiating and maintaining communications and exchanging data with other networked devices. For the disclosed aspects, processing sub-systems of computing platform 200 includes any processing sub-system portion used in conjunction with data record enrichment engine 210, tools, routines, sub-routines, applications, sub-applications, sub-modules thereof.

In specific embodiments of the present invention, computing platform 200 additionally includes a communications module (not shown in FIG. 2) embodied in hardware, firmware, software, and combinations thereof, that enables electronic communications between components of computing platform 200 and other networks and network devices. Thus, communication module includes the requisite hardware, firmware, software and/or combinations thereof for establishing and maintaining a network communication connection with one or more devices and/or networks. In the present invention, communication module is configured to work in conjunction with the APIs 206 to access/scan the data records 110 in data repository 100.

As previously discussed in relation to FIG. 1, memory 202 stores data record enrichment engine 210, which is executable by at least one of the computing processor device(s) 204. Data record enrichment includes artificial intelligence 210, which includes, but is not limited to machine learning model(s) and generative artificial intelligence.

Data record enrichment engine 210 is configured to implement machine learning (ML) model(s) 230 to access and scan the plurality of data records 110 to identify gaps 232 in the user specific data 130 of the plurality of data records 232. Gaps may include, but are not limited to, (i) factual data gaps 232-1, such as physical and digital addresses, (ii) behavioral gaps 232-2, such as how a user interacts with an application, online service or website, including engagement frequency, transaction history and the like, (iii) preference gaps 232-3, such as a user's like and dislikes or product/service preferences, (iv) intent gaps 232-5, such as user goals, motivations, interests and (v) behavior prediction gaps, such as future acquisitions, life events and the like.

For each of the one or more gaps 232 in one or more of the data records 110, data record enrichment engine 210 is configured to implement Generative AI (GenAI) 240 to generate one or more user-specific queries 242. The user-specific queries 242 are configured to solicit responses from a corresponding user 120 that serve to address an associated gap 232 in the corresponding data record 110. In specific embodiments of the system 10, the user-specific queries are generated iteratively 244, such that a response to a query may cause the Gen AI 240 to generate, in real-time, a follow-up query in order hone in on a response, or a collection of responses, which will address/satisfy the gap 232. The follow-up query may be based on a last-in-time response to the previous query or, in stances in which multiple follow-up queries are warranted, the follow-up query may be based on a combination of responses to previous queries. In such embodiments of the system, the generation of queries may continue, iteratively, until one response or a combination of responses to determined to address the gap 232. In this regard, further ML models (not shown in FIG. 2) may be implemented to determine whether or not a response or a combination of responses address the gap 232.

In specific embodiments of the system, data record enrichment engine 210 is configured to implement second ML models 270 to determine an optimal learning modality 272 for presenting the user-specific query(s) 242 to the user and/or an optimal communication channel 274 for delivering the user-specific query(s) 242 to the user. The optimal learning modality 272 and/or optimal communication channel 274 are the learning modality and communication channel that a specific user is most likely to engage (i.e., provide responses). Learning modalities may include, but are not limited to, questionnaires, quizzes, competitions/challenges, surveys and the like. Communication channels may include email (direct or indirect (i.e., link to queries), text, widget embedded within an application or portal, online/onsite or the like). In addition, the optimal learning modality 272 and/or optimal communication channel may be specific to or otherwise based on the query 242 and/or the gap 232 being addressed.

As discussed in relation to FIG. 1, in response to generating the user-specific queries 232 and, in some embodiments determining optimal learning modality and/or communication channel, data record enrichment engine 210 provides for presentation 250/communication of the user-specific queries 242 to the corresponding user 120 and, in response to presentation 250, receiving response(s) 252 to each of the one or more user-specific queries 252.

In further specific embodiments of the system, data record enrichment engine 210 is configured to implement third ML models and/or Natural Language Processing (NLP) 280 to detect patterns in responses 252 to the user-specific queries 242 to render a detected or predicted emotional state 282 of the user. In specific embodiments of the system 10, the detected or predicted emotional state 282 may be the data that addresses the gap. While in other embodiments of the invention, the update 260 of the data record may include associating the detected or predicted emotional state 282 of the user data that addresses the gap. In further embodiments of the system 10 in which iterative follow-up queries are generated, the detected or predicted emotional state 282 of the user may be taken into consideration, along with previous response(s), when determining the follow-up query(s) that should be generated.

In response to receiving the response(s) 252, data record enrichment engine 210 is configured to update 260, corresponding data record(s) 110 based on the responses 252 to the user-specific queries 242. Update 260 of the data record(s) 110 addresses at least one of previously identified gaps 232 in the corresponding data record 110. In specific embodiments of the system 10, further ML models or Gen AI (not shown in FIG. 2) may be implemented determine how to address a gap 232 based on the response(s) 252 (i.e., what to include in the data record, such as dialogue or the like).

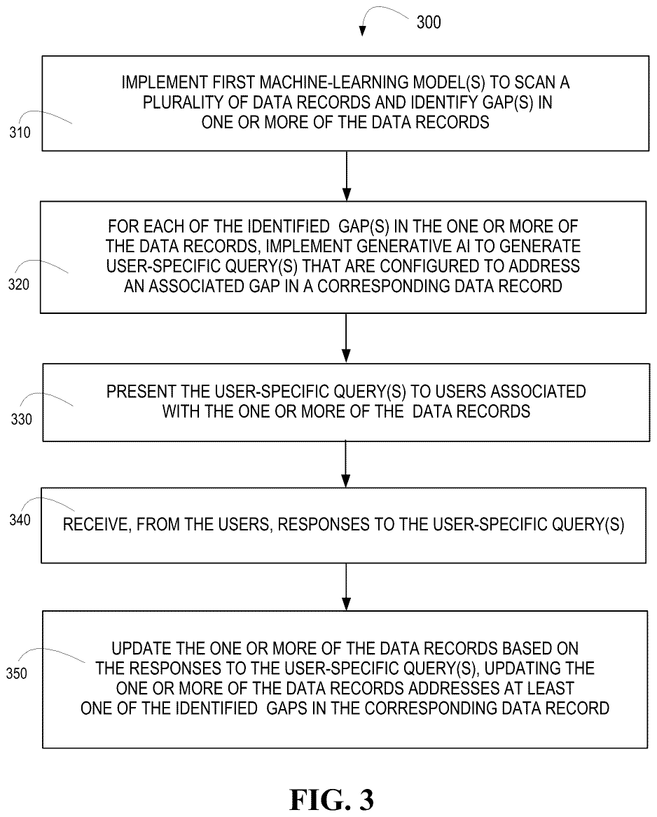

Referring to FIG. 3, a flow diagram is depicted of a method 300 for data record enhancement, in accordance with embodiments of the present invention. At Event 310, first ML models are implemented to scan a plurality of data records for the purpose of identifying gaps in the one or more of the data records. As previously discussed, a gap is not merely a missing entry in a data field, but may include other missing information, such as the user's predicted intents/goals, current or predicted emotional states, which may drive user preferences and the like. Thus, the identification of gaps requires analytical analysis of the data records as performed by the first ML models.

For each of the identified gaps in the one or more data records, at Event 320, GenAI is implemented to generate user-specific queries that are configured to address an associated gap in a corresponding data record. In specific embodiments the user-specific query(s) for an identified gap may be a series (two or more) of queries. Moreover, in specific embodiments of the invention, the user-specific queries are generated iteratively and in real-time, such that a response to a query caused the GenAI to generate one or more follow-up queries.

In response to generating the user-specific queries, at Event 330, the query(s) are presented to the user associated with the data record. In specific embodiments of the method, further ML model(s) are implemented to determine optimal learning modal and/or communication channel for presenting/delivering the queries to the user. In other embodiments of the method, user preferences may dictate the learning modality and/or communication channel.

In response to query presentation, at Event 340, responses to the query(s) are received from the users. In specific embodiments of the method, further ML models are implemented to detect patterns in the responses that indicate an actual/detected or predicted emotional state of the user. In such embodiments of the method, the actual/detected or predicted emotional state of the user may be the data required to address the gap, may be associated with the data required to address gap (and thus noted in the data record when subsequently updating the data record) and/or used as an input when determining iterative follow-up queries.

In response to receiving responses to the query(s), at Event 360, the data record is updated based on the responses to address at least one of the identified gaps in the data record. In specific embodiments of the invention ML model(s) and/or GenAI is implemented to determine and/or generate the data that addresses the gap (e.g., free-form dialogue or the like).

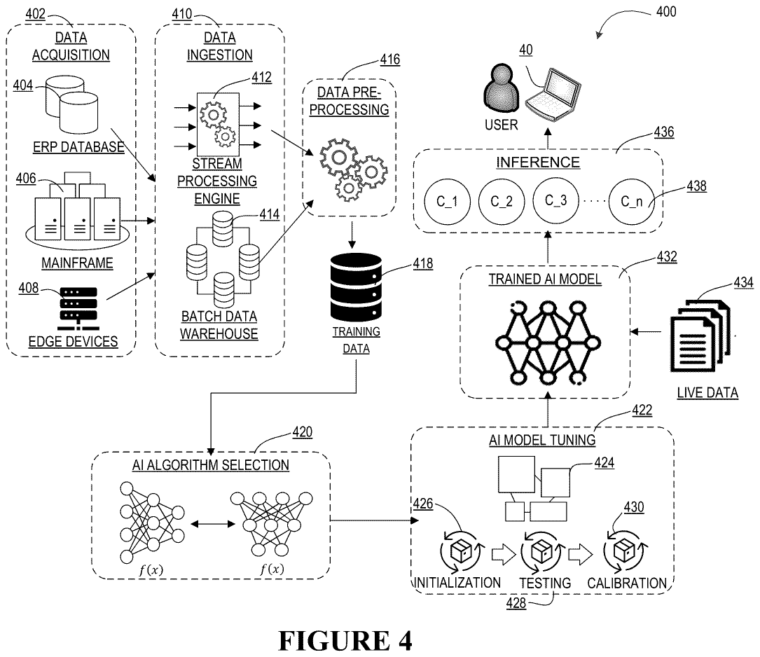

FIG. 4 illustrates an exemplary machine learning (ML) subsystem architecture 400, in accordance with an embodiment of the invention. The machine learning subsystem 400 may include a data acquisition engine 402, data ingestion engine 410, data pre-processing engine 416, ML model tuning engine 422, and inference engine 436.

The data acquisition engine 402 may identify various internal and/or external data sources to generate, test, and/or integrate new features for training the machine learning model 424. These internal and/or external data sources 404, 406, and 408 may be initial locations where the data originates or where physical information is first digitized. The data acquisition engine 402 may identify the location of the data and describe connection characteristics for access and retrieval of data. In some embodiments, data is transported from each data source 404, 406, or 408 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, these data sources 404, 406, and 408 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 402 from these data sources 404, 406, and 408 may then be transported to the data ingestion engine 410 for further processing.

Depending on the nature of the data imported from the data acquisition engine 402, the data ingestion engine 410 may move the data to a destination for storage or further analysis. Typically, the data imported from the data acquisition engine 402 may be in varying formats as they come from diverse sources, including RDBMS, other types of databases, S3 buckets, CSVs, or from streams. Since the data comes from different places, it needs to be cleansed and transformed so that it can be analyzed together with data from other sources. At the data ingestion engine 402, the data may be ingested in real-time, using the stream processing engine 412, in batches using the batch data warehouse 414, or a combination of both. The stream processing engine 412 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 414 collects and transfers data in batches according to scheduled intervals, trigger events, or any other logical ordering.

In machine learning, the quality of data and the useful information that can be derived therefrom directly affects the ability of the machine learning model 424 to learn. The data pre-processing engine 416 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed.

In addition to improving the quality of the data, the data pre-processing engine 416 may implement feature extraction and/or selection techniques to generate training data 418. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 418 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 422 may be used to train a machine learning model 424 using the training data 418 to make predictions or decisions without explicitly being programmed to do so. The machine learning model 424 represents what was learned by the selected machine learning algorithm 420 and represents the rules, numbers, and any other algorithm-specific data structures required for classification. Selecting the right machine learning algorithm may depend on a number of distinct factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, or the like), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, or the like), an instance-based method (e.g., k-nearest neighbor, learning vector quantization, self-organizing map, or the like), a regularization method (e.g., ridge regression, least absolute shrinkage and selection operator, elastic net, or the like), a decision tree learning method (e.g., classification and regression tree, iterative dichotomiser 3, C4.5, chi-squared automatic interaction detection, decision stump, random forest, multivariate adaptive regression splines, gradient boosting machines, or the like), a Bayesian method (e.g., naïve Bayes, averaged one-dependence estimators, Bayesian belief network, or the like), a kernel method (e.g., a support vector machine, a radial basis function, or the like), a clustering method (e.g., k-means clustering, expectation maximization, or the like), an associated rule learning algorithm (e.g., an Apriori algorithm, an Eclat algorithm, or the like), an artificial neural network model (e.g., a Perceptron method, a back-propagation method, a Hopfield network method, a self-organizing map method, a learning vector quantization method, or the like), a deep learning algorithm (e.g., a restricted Boltzmann machine, a deep belief network method, a convolution network method, a stacked auto-encoder method, or the like), a dimensionality reduction method (e.g., principal component analysis, partial least squares regression, Sammon mapping, multidimensional scaling, projection pursuit, or the like), an ensemble method (e.g., boosting, bootstrapped aggregation, AdaBoost, stacked generalization, gradient boosting machine method, random forest method, or the like), and/or the like.

To tune the machine learning model, the ML model tuning engine 422 may repeatedly execute cycles of experimentation 426, testing 428, and tuning 430 to optimize the performance of the machine learning algorithm 420 and refine the results in preparation for deployment of those results for consumption or decision making. To this end, the ML model tuning engine 422 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 418. A fully trained machine learning model 432 is one whose hyperparameters are tuned and model accuracy maximized.

The trained machine learning model 432, similar to any other software application output, can be persisted to storage, file, memory, or application, or looped back into the processing component to be reprocessed. More often, the trained machine learning model 432 is deployed into an existing production environment to make practical business decisions based on live data 434. To this end, the machine learning subsystem 400 uses the inference engine 436 to make such decisions. The type of decision-making may depend upon the type of machine learning algorithm used. For example, machine learning models trained using supervised learning algorithms may be used to structure computations in terms of categorized outputs (e.g., C_1, C_2 . . . C_n 438) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . C_n 438) live data 434 based on how similar they are to one another to solve exploratory challenges where little is known about the data, provide a description or label (e.g., C_1, C_2 . . . C_n 438) to live data 434, such as in classification, and/or the like. These categorized outputs, groups (clusters), or labels are then presented to the user input system 40. In still other cases, machine learning models that perform regression techniques may use live data 434 to predict or forecast continuous outcomes.

It will be understood that the embodiment of the machine learning subsystem 400 illustrated in FIG. 4 is exemplary and that other embodiments may vary. As another example, in some embodiments, the machine learning subsystem 300 may include more, fewer, or different components.

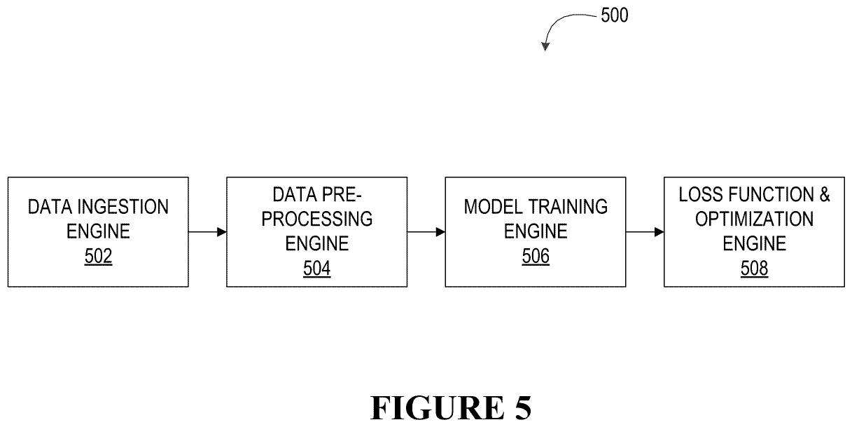

FIG. 5 illustrates an exemplary generative AI subsystem 500, in accordance with an embodiment of the invention. The generative AI subsystem 500 may include a data ingestion engine 502, a data pre-processing engine 504, and a model training engine 506. It should be understood that the generative AI subsystem 500 is merely an example, and other embodiments may include more, fewer, or different components depending on the specific requirements and implementations of the system. For instance, additional engines for data validation, feature selection, or distributed computing may be integrated into the subsystem, or certain components described herein may be consolidated or omitted based on system performance objectives. Therefore, the generative AI subsystem 500 should not be considered limiting and may be adapted to various configurations within the scope of the invention.

The data ingestion engine 502 may identify various internal and/or external data sources to generate, test, and/or integrate new features for training the generative AI model. These internal and/or external data sources may be initial locations where the data originates or where physical information is first digitized. In addition to conventional data sources, the data ingestion engine 502 may support decentralized storage systems, such as blockchain-based data sources, and privacy-preserving methods such as differential privacy. The data ingestion engine % 02 may identify the location of the data and describe connection characteristics for access and retrieval of data. In some embodiments, data is transported from each data source using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like.

Depending on the nature of the data, the data ingestion engine 502 may move the data to a destination for storage or further analysis. Typically, the data may be in varying formats as they come from different sources, including RDBMS, other types of databases, S3 buckets, CSVs, or from streams. Since the data comes from different places, it needs to be cleansed and transformed so that it can be analyzed together with data from other sources. The data may be ingested in real-time, using stream processing, in batches using a batch data warehouse, or a combination of both. Stream processing may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse collects and transfers data in batches according to scheduled intervals, trigger events, or any other logical ordering.

In machine learning, the quality of data and the useful information that can be derived therefrom directly affects the ability of the machine learning model to learn. The data pre-processing engine 504 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed. In some embodiments, the data pre-processing engine 504 may perform real-time pre-processing at the edge via edge computing devices, allowing for the transformation and reduction of data prior to transmission to centralized locations, thereby reducing latency and conserving network bandwidth.

In addition to improving the quality of the data, the data pre-processing engine 504 may transform categorical data into numerical formats that are suitable for machine learning algorithms. In this regard, the data pre-processing engine 504 may use techniques such as one-hot encoding or label encoding depending on the nature of the categorical variables and the intended use of the data.

In some embodiments, the data pre-processing engine 504 may also include dimensionality reduction techniques, where the number of input features is reduced while retaining the most relevant information. In this regard, the data pre-processing engine 504 may include methods such as Principal Component Analysis (PCA) or apply feature selection algorithms to remove redundant or irrelevant features, thereby reducing the computational complexity of the model training phase. Feature selection may be particularly beneficial in datasets with a high number of features, ensuring that the generative AI models do not overfit to noise or irrelevant details. The pre-processed data output from the data pre-processing engine 504 may then be fed into the model training module 506.

The model training engine 506 may be responsible for training the generative AI models using the pre-processed data from the data pre-processing engine 504. The model training engine 506 may implement various machine learning algorithms, including but not limited to Generative Adversarial Networks (GANs), Variational Autoencoders (VAEs), or other generative models, depending on the specific requirements of the system. The model training engine 506 may optimize these models by continuously adjusting their internal parameters based on the patterns and relationships identified within the data.

In some embodiments, the model training engine 506 may include a training data handler, which manages the partitioning of the pre-processed data into training, validation, and testing datasets. The training data is used to update the model's parameters, while the validation and testing datasets are reserved to evaluate the model's performance during and after training. The model training engine 506 may support various data-handling strategies, such as cross-validation or random shuffling, to ensure that the model generalizes well and is not overfitting to the training data.

For VAEs, the model training engine 506 may implement an encoder-decoder architecture. In this architecture, the encoder is responsible for compressing or mapping the input data into a lower-dimensional latent space representation, capturing the essential features of the input data while discarding unnecessary details. The decoder, in turn, reconstructs the input data from this latent representation, aiming to recreate the original data as closely as possible. During training, the VAE model seeks to minimize a loss function that typically consists of two components: reconstruction loss and Kullback-Leibler (KL) divergence loss.

The reconstruction loss ensures that the difference between the original input and the reconstructed output is minimized, guiding the decoder to generate outputs that closely resemble the input data. The second component, KL divergence loss, regularizes the latent space by ensuring that the distribution of latent variables conforms to a predefined probabilistic distribution, often a Gaussian distribution. This constraint encourages the model to learn a well-organized and smooth latent space, allowing for meaningful sampling from this space during inference. By combining these loss functions, the VAE can learn a latent space that not only captures the underlying patterns in the data but also allows for the generation of novel outputs by sampling new points from this space. During the inference phase, the trained model can sample random points from the latent space to generate new, previously unseen data instances.

In training generative AI models, the model training engine 506, which includes an optimization module 508, may implement various optimization techniques to improve model performance and efficiency. The optimization module 508 is responsible for adjusting the model's internal parameters continuously, using feedback from relevant loss functions tailored to the application (e.g., text, image, audio, or video generation). Techniques such as gradient clipping, learning rate scheduling, and mixed-precision training are applied by the optimization module 508 to stabilize and fine-tune the training process. Gradient clipping may be used to stabilize the training process, especially in transformer-based models, by capping the magnitude of gradients to prevent them from becoming excessively large. Learning rate scheduling may involve gradually increasing the learning rate during initial training phases (warm-up) and then decaying it as training progresses to fine-tune the model's parameters more effectively. Mixed-precision training, which leverages lower-precision (e.g., float16) arithmetic while retaining higher precision (e.g., float32) for specific calculations, may be used to accelerate training and reduce memory consumption, enabling the model to scale efficiently even when trained on large datasets.

In embodiments using GANs, the model training engine 506 may train two distinct but interconnected networks: the generator and the distinguisher. The generator network is responsible for generating synthetic data samples, typically starting from random noise vectors or points sampled from a latent space. The generator's objective is to learn how to map this random input into realistic data that closely resembles the actual data distribution from the training set, such as images, financial plans, or any other domain-specific data. On the other side, the distinguisher network is tasked with differentiating between the real data—coming directly from the training set—and the synthetic data generated by the generator. The distinguisher acts as a binary classifier, aiming to correctly classify whether the input data is real or fake. Its job is to improve its accuracy over time in detecting whether the data it is evaluating comes from the true data distribution or has been synthetically created by the generator.

The training process of a GAN is adversarial in nature, where the two networks engage in a zero-sum contest. The generator continuously tries to improve its ability to generate convincing data, while the distinguisher simultaneously improves its capacity to distinguish between real and generated data. During each training iteration, the generator attempts to “fool” the distinguisher by creating more realistic data samples, while the distinguisher receives feedback to better catch fake data. This adversarial feedback loop leads both networks to improve their performance over time. The loss functions for both networks guide this competition: the generator's loss reflects how well it was able to fool the distinguisher, while the distinguisher's loss reflects how accurately it classified real versus generated data. Through this iterative, competitive process, the generator becomes increasingly skilled at producing highly realistic data samples that are difficult for the distinguisher to differentiate from real data. Eventually, the generator learns to generate synthetic data that is nearly indistinguishable from the real data.

The loss function & optimization engine 508 includes a parameter optimization module, which may optimize the model's parameters using gradient-based optimization techniques such as stochastic gradient descent (SGD), Adam, or other suitable algorithms. The optimization process may minimize the loss function calculated during each training iteration (or epoch), adjusting the weights and biases of the model to improve its ability to learn from the data. The parameter optimization module may also dynamically adjust learning rates, momentum, and other hyperparameters to further enhance training efficiency.

In some embodiments, the model training engine 506 may implement early stopping mechanisms to prevent overfitting. Early stopping monitors the generative AI model's performance on the validation dataset, halting the training process if the performance does not improve after a specified number of iterations. This ensures that the generative AI model does not continue training on noise or irrelevant patterns, which could degrade its performance on unseen data. The model training engine 506 may also support distributed training across multiple computing nodes, allowing the system to scale its computational resources as needed. Distributed training may involve splitting the generative AI model and data across multiple machines or GPUs, where each node processes a portion of the data and updates the model in parallel. This is particularly useful for large datasets or models that require significant computational power, such as deep generative models. The model training engine 506 may synchronize the updates across the nodes using techniques like synchronous or asynchronous gradient descent.

Once the generative AI model is trained, the model training engine 506 may save the final trained generative AI model in a persistent storage location for future use. In specific embodiments, metadata such as the number of epochs, the final loss values, and values of learned parameters may be logged for model versioning and/or retraining at a later stage. In some embodiments, the model training engine 506 may also implement transfer learning, where a pre-trained model is fine-tuned on a smaller, domain-specific dataset. This may reduce the amount of time and data required to train a new model, especially in cases where the available data is limited or highly specialized. The model training engine 506 may adjust the parameters of the pre-trained model to better align with the new dataset, while preserving the learned features from the original training.

In embodiments where a VAE is used to train the generative AI model, generating new output involves providing an input to the trained model in the form of a point or distribution in the latent space. During training, the encoder network learned to compress input data into this latent space, while the decoder learned to map points from the latent space back into meaningful data. To generate new data, the system may sample a point from the latent space, typically by sampling from a predefined distribution (e.g., a Gaussian distribution), or a user may provide specific coordinates within the latent space to control the nature of the output. The decoder network then transforms this latent vector into a new data instance (e.g., an image or piece of text) that conforms to the patterns learned during training. Since the latent space has been structured to capture the key features of the input data, small variations in the latent space coordinates may result in new data with slight variations, allowing the system to produce diverse but coherent outputs.

In embodiments where the generative AI model has been trained using a GAN, the process for generating new output also involves providing an input in the form of a random noise vector sampled from the latent space. Unlike VAEs, where the latent space is learned explicitly during training, GANs use this latent space as a starting point for the generator to produce new data. The trained generator network takes the random input vector and transforms it into a new data sample, such as an image, based on the patterns it has learned during training. The distinguisher is no longer needed in this phase, as its role was limited to training. Once the generator has been trained to produce realistic outputs, it can generate new data by mapping random noise vectors to complex data points that resemble the original dataset. For example, in a GAN trained on images of landscapes, providing a random vector in the latent space will result in the generation of a new, never-before-seen landscape that adheres to the patterns the generator learned during training. The latent space in GANs encodes abstract features of the data, and small adjustments to the noise vector allow users to control specific aspects of the generated data, such as color, shape, or texture, enabling the generation of highly varied outputs.

It will be understood that the embodiment of the generative AI subsystem 500 illustrated in FIG. 5 is exemplary and that other embodiments may vary. The generative AI subsystem 500, as well as its constituent elements, may vary, and modifications or alternative configurations may be implemented without departing from the broader scope of the invention. For instance, different machine learning algorithms, data sources, optimization techniques, or training methodologies may be employed depending on system requirements, application domain, and available computational resources. Furthermore, features and functionalities described in one embodiment may be combined with those of another embodiment as needed, and vice versa.

Thus, as described in detail above, present embodiments of the invention include systems, methods, computer program products and/or the like that provide for the enrichment of data records through the implementation of Artificial Intelligence (AI). In this regard, the invention implements machine learning model(s) to scan data records, such as user data records, to identify gaps. In response to identifying gaps in a data record, the invention uses Generative AI to generate one or more queries that that are data record-specific, e.g., user-specific and configured to address one or more of gaps in the data record. In specific instances the queries may be iteratively generated based on previous responses until the gap-filling data is identified. Once generated, the queries are presented to the data record subject, e.g., user. In specific instances, additional machine learning models, which have been trained on user behavior patterns, are implemented to determine optimal learning modalities (i.e., the type of queries) and/or optimal communication channels for presenting the queries to the user. In response to presenting the queries, responses to the queries are received and the data record is updated based on the responses, such that, the updating addresses one or more of the identified gaps.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for data enrichment, the system comprising:
a data repository including a first memory and one or more first computing processor devices in communication with the first memory, wherein the first memory stores a plurality of data records, each data record is associated with a user and including user-specific data; and
a computing platform including a second memory and one or more second computing processor devices in communication with the second memory, wherein the second memory stores a data record enrichment engine including artificial intelligence (AI), executable by at least one of the one or more computing processor devices and configured to:
implement one or more first machine-learning models to scan the plurality of data records and identify one or more gaps in one or more of the plurality of data records,
for each of the identified one or more gaps in the one or more of the plurality of data records, implement generative AI to generate one or more user-specific queries, wherein the one or more user-specific queries are configured to address an associated gap in a corresponding data record,
present the one or more user-specific queries to users associated with the one or more of the plurality of data records,
receive, from the users, responses to the one or more user-specific queries, and
update the one or more of the plurality of data records based on the responses to the one or more user-specific queries, wherein updating the one or more of the plurality of data records addresses at least one of the identified one or more gaps in the corresponding data record.

2. The system of claim 1, wherein the data record enrichment engine is further configured to:
implement one or more second machine learning models trained on user behavior patterns to determine one or more optimal learning modalities for the one or more user-specific queries, and
wherein the data record enrichment engine is configured to present the one or more user-specific queries to the users in the determined one or more optimal learning modalities.

3. The system of claim 2, wherein the data record enrichment engine is further configured to:
implement the one or more second machine learning models to determine one or more optimal learning modalities for the one or more user-specific queries, wherein each of the one or more optimal learning modalities are specific to at least one of (i) a user-specific query and (ii) a gap in the corresponding data record, and
wherein the data record enrichment engine is configured to present the one or more user-specific queries to the users in the determined one or more learning modalities.

4. The system of claim 1, wherein the data record enrichment engine is further configured to:
implement one or more second machine learning models trained on user behavior patterns to determine one or more optimal communication channels for presenting the one or more user-specific queries to each of the users, and
wherein the data record enrichment engine is configured to present the one or more user-specific queries to the users in the determined one or more optimal communication channels.

5. The system of claim 1, wherein the data record enrichment engine is further configured to:
implement at least one of (i) one or more second machine learning models and (ii) natural language processing (NLP) to identify patterns in the responses to the one or more user-specific queries to detect or predict an emotional state of the user, and
wherein the user data record enrichment engine is configured to update the one or more of the plurality of data records based on the responses to the one or more user-specific queries, wherein updating includes associating the detected or predicted emotional state of the user to at least one of the one or more gaps.

6. The system of claim 1, wherein the data record enrichment engine is further configured to:
in immediate response to receiving the responses to the users, implement the one or more machine learning models to determine and generate one or more additional user-specific queries based on one or more of the responses from an associated user, and
present the one or more additional user-specific queries to users associated with the one or more of the plurality of data records,
receive, from the users, responses to the one or more additional user-specific queries, and
update the one or more of the plurality of data records based on the responses to the one or more user-specific queries and the one or more additional user-specific queries, wherein updating the one or more of the plurality of data records addresses at least one of the identified one or more gaps in the corresponding data record.

7. The system of claim 6, wherein the data record enrichment engine is further configured to:
implement at least one of (i) one or more second machine learning models and (ii) natural language processing (NLP) to identify patterns in the responses to the one or more user-specific queries to detect or predict an emotional state of the user, and
wherein implementing the one or more machine learning models to determine and generate one or more additional user-specific queries based on (i) one or more of the responses from an associated user and (ii) the detected or predicted emotional state of the user.

8. The system of claim 6, wherein the data record enrichment engine is further configured to:
iteratively implement one or more machine learning models to determine and generate one or more additional user-specific queries based on one or more of previous responses from an associated user,
wherein the iterative determination and generation of the one or more additional user-specific queries continues until an associated gap is addressed.

9. The system of claim 1, wherein the one or more gaps in one or more of the plurality of data records include at least one of (i) user factual gap, (ii) behavioral gap, including predicted behavioral gap, (iii) preference gap, and (iv) intent gap.

10. A computer-implemented method for data enrichment, the computer-implemented is method executed by one or more computing processor devices and comprises:
implementing one or more first machine-learning models to scan a plurality of data records and identify one or more gaps in one or more of the plurality of data records;
for each of the identified one or more gaps in the one or more of the plurality of data records, implementing generative AI to generate one or more user-specific queries, wherein the one or more user-specific queries are configured to address an associated gap in a corresponding data record;
presenting the one or more user-specific queries to users associated with the one or more of the plurality of data records;
receiving, from the users, responses to the one or more user-specific queries; and
updating the one or more of the plurality of data records based on the responses to the one or more user-specific queries, wherein updating the one or more of the plurality of data records addresses at least one of the identified one or more gaps in the corresponding data record.

11. The computer-implemented method of claim 10, further comprising:
implementing one or more second machine learning models trained on user behavior patterns to determine at least one of (i) one or more optimal learning modalities and (ii) one or more optimal communication channels for presenting the one or more user-specific queries to a corresponding one of the users, and
wherein presenting further comprises presenting the one or more user-specific queries to the users using at least one of the determined (i) one or more optimal learning modalities and (ii) one or more optimal communication channels.

12. The computer-implemented method of claim 10, further comprising:
implementing at least one of (i) one or more second machine learning models and (ii) natural language processing (NLP) to identify patterns in the responses to the one or more user-specific queries to detect or predict an emotional state of the user, and
wherein updating further comprises updating the one or more of the plurality of data records based on the responses to the one or more user-specific queries, wherein updating includes associating the detected or predicted emotional state of the user to at least one of the one or more gaps.

13. The computer-implemented method of claim 10, further comprising:
in immediate response to receiving the responses to the users, implementing the one or more machine learning models to determine and generate one or more additional user-specific queries based on one or more of the responses from an associated user;
presenting the one or more additional user-specific queries to users associated with the one or more of the plurality of data records; and
receiving, from the users, responses to the one or more additional user-specific queries, and
wherein updating further comprises updating the one or more of the plurality of data records based on the responses to the one or more user-specific queries and the one or more additional user-specific queries, wherein updating the one or more of the plurality of data records addresses at least one of the identified one or more gaps in the corresponding data record.

14. The computer-implemented method of claim 13, further comprising:
implementing at least one of (i) one or more second machine learning models and (ii) natural language processing (NLP) to identify patterns in the responses to the one or more user-specific queries to detect or predict an emotional state of the user, and
wherein implementing the one or more machine learning models to determine and generate one or more additional user-specific queries is based on (i) one or more of the responses from an associated user and (ii) the detected or predicted emotional state of the user.

15. The computer-implemented method of claim 13, wherein implementing the one or more machine learning models to determine and generate one or more additional user-specific queries further comprises iteratively implementing the one or more machine learning models to determine and generate one or more additional user-specific queries based on one or more of previous responses from an associated user,
wherein the iterative determination and generation of the one or more additional user-specific queries continues until an associated gap is addressed.

16. A computer program product including a non-transitory computer-readable medium, the non-transitory computer-readable medium comprising sets of codes for causing one or more computing devices to:
implement one or more first machine-learning models to scan a plurality of data records and identify one or more gaps in one or more of the plurality of data records;
for each of the identified one or more gaps in the one or more of the plurality of data records; implement generative AI to generate one or more user-specific queries, wherein the one or more user-specific queries are configured to address an associated gap in a corresponding data record;
present the one or more user-specific queries to users associated with the one or more of the plurality of data records;
receive, from the users, responses to the one or more user-specific queries; and
update the one or more of the plurality of data records based on the responses to the one or more user-specific queries, wherein updating the one or more of the plurality of data records addresses at least one of the identified one or more gaps in the corresponding data record.

17. The computer program product of claim 16, wherein the sets of codes further comprise a set of codes for causing the one or more computing devices to:
implement one or more second machine learning models trained on user behavior patterns to determine at least one of (i) one or more optimal learning modalities and (ii) one or more optimal communication channels for presenting the one or more user-specific queries to a corresponding one of the users, and
wherein the sets of codes for causing the one or more computing devices to present are further configured to cause the one or more computing devices to present the one or more user-specific queries to the users using at least one of the determined (i) one or more optimal learning modalities and (ii) one or more optimal communication channels.

18. The computer program product of claim 16, wherein the sets of codes further comprise a set of codes for causing the one or more computing devices to:
implement at least one of (i) one or more second machine learning models and (ii) natural language processing (NLP) to identify patterns in the responses to the one or more user-specific queries to detect or predict an emotional state of the user, and
wherein the set of codes configured to cause the one or more computing devices to update are further configured to cause the one or more computing devices to update the one or more of the plurality of data records based on the responses to the one or more user-specific queries, wherein updating includes associating the detected or predicted emotional state of the user to at least one of the one or more gaps.

19. The computer program product of claim 16, wherein the sets of codes further comprise sets of codes for causing the one or more computing devices to:
in immediate response to receiving the responses to the users, implement the one or more machine learning models to determine and generate one or more additional user-specific queries based on one or more of the responses from an associated user;
present the one or more additional user-specific queries to users associated with the one or more of the plurality of data records; and
receive, from the users, responses to the one or more additional user-specific queries, and
wherein the set of codes configured to cause the one or more computing devices to update are further configured to cause the one or more computing devices to update the one or more of the plurality of data records based on the responses to the one or more user-specific queries and the one or more additional user-specific queries, wherein updating the one or more of the plurality of data records addresses at least one of the identified one or more gaps in the corresponding data record.

20. The computer program product of claim 19, wherein the sets of codes further comprise sets of codes for causing the one or more computing devices to:
implement at least one of (i) one or more second machine learning models and (ii) natural language processing (NLP) to identify patterns in the responses to the one or more user-specific queries to detect or predict an emotional state of the user, and
wherein the set of codes configured to cause the one or more computing devices to implement the one or more machine learning models to determine and generate one or more additional user-specific queries are further configured to cause the one or more computing devices to implement the one or more machine learning models to determine and generate one or more additional user-specific queries based on (i) one or more of the responses from an associated user and (ii) the detected or predicted emotional state of the user.
